(19) United States
(12) Patent Application Publication
(10) Pub. No.: US 2018/0310707 A1
(43) Pub. Date: Nov. 1, 2018

(54) KIT FOR ASSEMBLING FURNITURE

(71) Applicant: IBK PROJECT SRL, Pesaro (IT)

(72) Inventor: Massimo BERLONI, Pesaro (IT)

(73) Assignee: IBK PROJECT SRL, Pesaro (IT)

(21) Appl. No.: 15/770,291

(22) PCT Filed: Oct. 26, 2016
(86) PCT No.: PCT/EP2016/075842

§ 371 Date: Apr. 23, 2018

(30) Foreign Application Priority Data
Oct. 29, 2015 (IT) 202015000066688

(51) Int. Cl. A47B 47/00; F16B 12/10; F16B 5/00; F16B 5/02

(52) U.S. Cl. CPC A47B 47/0025; F16B 12/10; F16B 2012/103; F16B 5/0225; F16B 5/0024

(57) ABSTRACT

A kit for assembling furniture, which comprises at least one panel, which defines externally two mutually opposite greater faces which are mutually joined by four side faces, at least one joining batten, and means of coupling between the panel and the batten; the coupling means comprise: a collar, which can be inserted into at least one first seat provided at one of the greater faces, and at least one pin, which can be partially inserted into at least one second seat provided at one of the side faces. The second seat leads to the first seat, in order to allow the introduction of a first end portion of the pin into a transverse hole of the collar, which is previously inserted into the first seat, with consequent definition of at least one intermediate configuration of assembly.

The present invention relates to a kit for assembling furniture.

As is known, furniture intended for furnishing kitchens, bathrooms, offices, living rooms etc., are increasingly often obtained from kits made up of panels, shelves, fixing elements, accessories etc., which have to be mutually coupled and assembled in order to obtain the desired furniture.

Assembly of the piece of furniture can be done by a professional technician or, typically, by the end consumer, and, with regard to such latter option, the manufacturing companies must obviously pay the utmost attention to the simplicity of installation.

Solutions of the type mentioned above are often found to be sufficiently versatile, since by suitably designing and providing the components of the kit, they leave the installation technician and/or the end consumer with the ability to provide furniture according to different configurations, forms and dimensions.

This evidently is highly appreciated, since it makes it possible to adjust the end product to the tastes and specific requirements of each purchaser, in particular in terms of available space.

Such implementation solutions are not devoid of drawbacks, however.

It should in fact be noted that the versatility and, more generally, the possibility to provide different configurations are effectively limited by the difficulty (impossibility) of combining components that are made of different materials, or in any case by the difficulty of using materials other than wood.

Usually in fact, conventional kits comprise fixing elements of the type of screws, nails, and other accessory elements, which according to various methods make it possible for the installation technician (and/or the purchaser) to couple together panels of wood, intended to make up the furniture.

The specific implementation solutions adopted have limitations that discourage their use (or prohibit it completely) for coupling modular elements that are hollow and/or made (for example) of metal, ceramic materials, composite materials or polymeric materials.

Likewise, conventional fixing elements anchor the panels together with forces of limited intensity and therefore they provide low resistance to stresses, and are thus even more inadequate when it is desired to provide furniture made up (at least partially) of panels, shelves, drawers etc., constituted by metallic, ceramic or polymeric materials.

It thus appears evident that the impossibility of using materials other than wood limits the variety of configurations that can be obtained and, especially, the possible applications, and this is very unwelcome.

For example in fact, evidently wooden furniture cannot be exposed to bad weather, and therefore the kits described up to now cannot be used for the composition of outdoor furniture.

More generally, the consumer cannot use the kits for kitchens and/or other furniture, in materials that are stronger or more prized.

It should further be noted that the kits described up to now provide the mutual coupling between the components in a way that is often not reversible, thus impeding the practical substitution of a single damaged component, or the partial reconfiguration of the piece of furniture, in order to assign it for a different use.

The aim of the present invention is to solve the above mentioned problems, by providing a kit that makes it possible to stably couple together components intended to define furniture.

Within this aim, an object of the invention is to provide a versatile kit that makes it possible in a practical manner to assemble furniture according to various configurations.

Another object of the invention is to provide a kit that makes it possible to assemble furniture made of materials of any kind, even by coupling together components made of different materials.

Another object of the invention is to provide a kit that allows the partial disassembly of individual components, in a practical and easy manner.

Another object of the invention is to provide a kit that allows subsequent reconfigurations of the furniture obtained, and also the variation or addition of new functionalities, after the first assembly thereof.

Another object of the invention is to provide a kit that ensures a high reliability of operation and high resistance to stresses, conferring great solidity and strength on the furniture obtained.

Another object of the invention is to provide a kit that makes it possible to assemble furniture that is adapted to furnish outdoor spaces, exposed to bad weather.

Another object of the invention is to provide a kit that adopts an alternative technical and structural architecture to those of conventional kits.

Another object of the invention is to provide a kit that can be easily implemented using elements and materials that are readily available on the market.

Another object of the invention is to provide a kit that is low cost and safely applied.

This aim and these and other objects which will become better apparent hereinafter are all achieved by a kit 1 according to claim 1.

Further characteristics and advantages of the invention will become better apparent from the description of a preferred, but not exclusive, embodiment of the kit according to the invention, which is illustrated by way of non-limiting example in the accompanying drawings wherein:

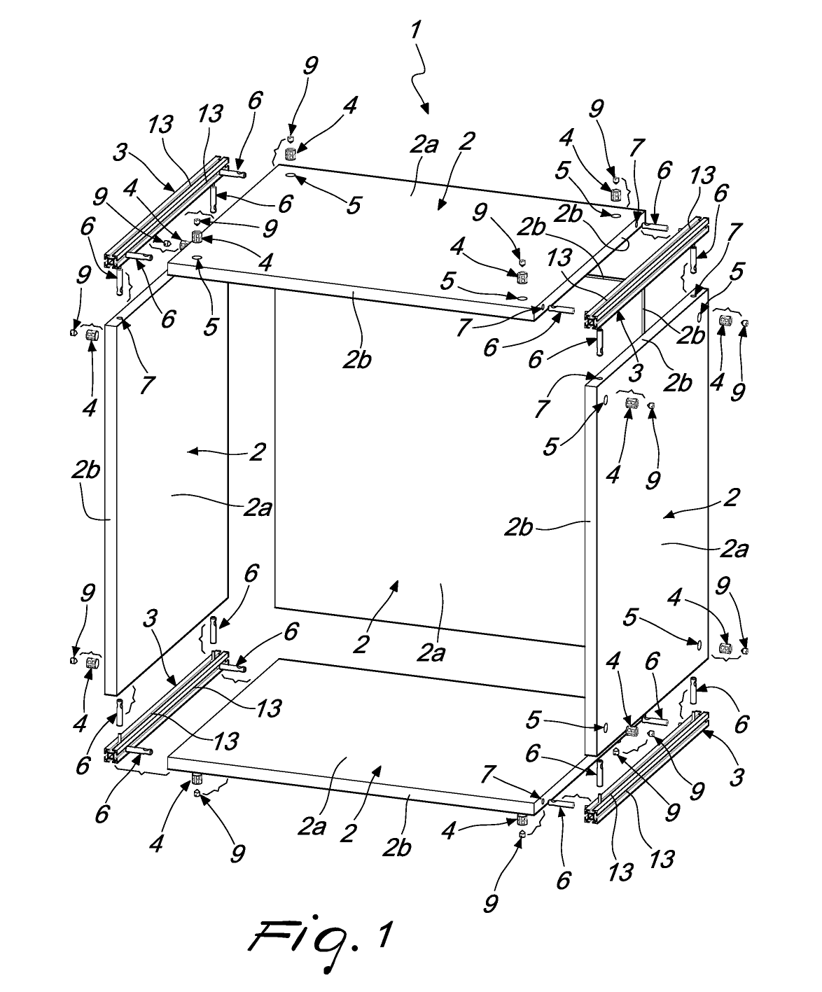

FIG. 1 is an exploded perspective view of a kit according to the invention;

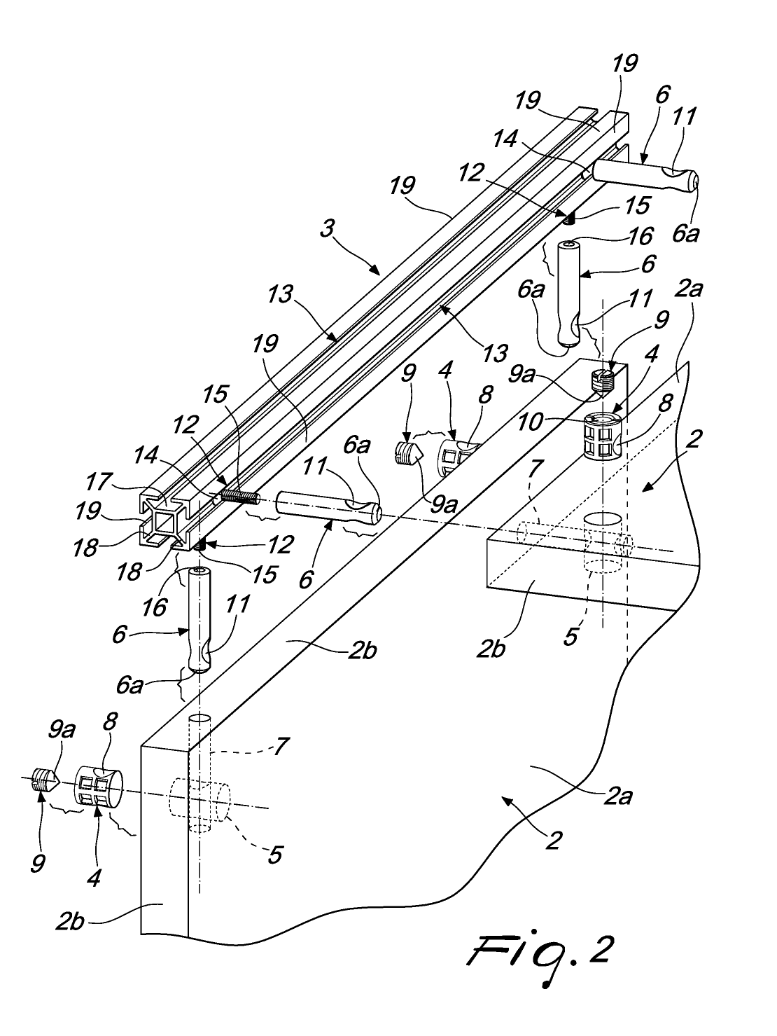

FIG. 2 is a greatly enlarged detail of FIG. 1;

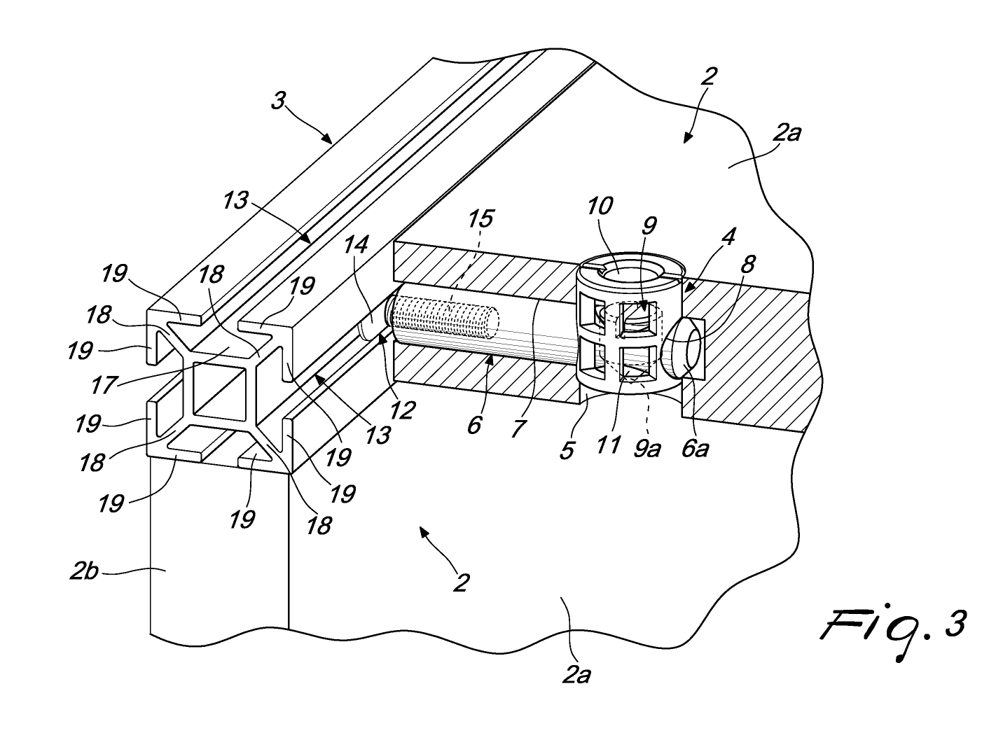

FIG. 3 is a partially cross-sectional perspective view showing the coupling between a panel and a batten.

With reference to the figures, the reference numeral 1 generally designates a kit that can be effectively used to assemble furniture of various types (or parts thereof).

First of all, the kit 1 therefore comprises at least one panel 2, which defines externally two mutually opposite greater faces 2a, which are mutually joined by four side faces 2b (which are also, obviously, in mutually opposite pairs).

Typically (but not exclusively), the panel 2 has a squashed parallelepiped shape structure and is designed to constitute a basic unit for providing furniture of various types.

Furthermore, the kit 1 comprises at least one joining batten 3. In addition, the kit 1 comprises means of coupling between the panel 2 and the joining batten 3.

According to the invention, such coupling means comprise first of all at least one collar 4 (preferably cylindrical, while not ruling out the possibility of making it prismatic or otherwise), which can be inserted into at least one first seat 5. The first seat 5 is provided at one of the greater faces 2a.

In this regard, in the embodiment proposed in the accompanying figures the first seat 5 is constituted substantially by a cylindrical hole (dead or through, cylindrical or other shape) which is open at a greater face 2a (or at both of them). Such embodiment can for example be adopted when the panel 2 is not internally hollow; in any case it should be observed that the kit 1 can effectively also be used for hollow panels 2: in such case, the first seat 5 will be constituted solely by the opening (and optionally by a guiding portion) provided on the greater face 2a.

Furthermore, the coupling means comprise at least one pin 6, which can be partially inserted into at least one second seat 7 provided at one of the side faces 2b.

The pin 6 and the second seat 7 also preferably have a substantially cylindrical shape structure, but, again, the possibility is not ruled out of providing them in different shapes (including envisaged use on hollow panels 2), which in any case remain within the scope of protection claimed herein.

As can be seen from FIGS. 2 and 3, the second seat 7 (shown in dotted lines in FIG. 2) leads to the first seat 5 (also shown in dotted lines in FIG. 2): by virtue of such specific implementation choice, a first end portion 6a of the pin 6 can be introduced into a transverse hole 8 of the collar 4, which in turn is previously inserted into the first seat 5. This makes it possible to define at least one intermediate configuration of assembly, in which the pin 6 partially protrudes from the second seat 7 and, at the opposite end, its first end portion 6ais contained internally, until it is introduced into the hole 8 of the collar 4.

Furthermore, the coupling means comprise a threaded peg 9; when the pin 6 is arranged in the intermediate configuration described above, the peg 9 can be inserted into a female thread 10 provided in the collar 4, until the peg 9 is accommodated at least partially in an eyelet 11 provided along the first end portion 6a of the pin 6.

This makes it possible to obtain the desired coupling between the panel 2 (to which the pin 6 is now stably coupled) and the batten 3, since the latter is clamped by a protrusion 12 (shown for the sake of simplicity only in FIGS. 2 and 3), which can in fact be coupled to a side wall of the batten 3 and is associated stably with the pin 6, at the opposite end with respect to the first end portion 6a.

The methods with which the desired coupling is obtained are in particular clearly visible in the accompanying FIG. 3.

It should be noted that the collar 4, the pin 6 and the peg 9 can be made of any material, although preferably they are made of metal.

In particular, in the preferred embodiment, shown in the accompanying figures by way of non-limiting example, one end 9a of the peg 9 (the one intended to be inserted first into the first seat 5), has an externally-facing progressively tapered shape (it is therefore, typically, conical or frustum-shaped).

Conveniently, this makes it possible to obtain the automatic alignment with the eyelet 11, which in turn is internally countersunk, as a result of the progressive screwing of the peg 9 into the female thread 10.

More precisely, by virtue of such implementation choice it is not necessary in the intermediate configuration to achieve a perfect alignment of the eyelet 11 with the longitudinal axis of the collar 4 and of the first seat 5. In fact, in the event of a partial misalignment, the shape structure chosen for the end 9a and for the eyelet 11 causes, with the progressive advancement (screwing) of the peg 9, the automatic centering of the eyelet 11 with respect to the latter, and therefore the movement of the pin 6, which makes it possible to obtain the optimal positioning of the latter with respect to the second seat 7.

In addition, by deliberately taking care, in the intermediate configuration, to keep the pin 6 protruding more than in the condition of optimal alignment, the screwing of the peg 9 and the consequent movement of the pin 6 also produces the improved clamping of the batten 3 by the protrusion 12 (which is previously associated, with play, with the batten 3), by virtue of the traction force developed by the pin 6 during its movement toward optimal alignment.

With further reference to the preferred embodiment, and to the accompanying figures, the protrusion 12 is slideably insertable into a longitudinal track 13, defined by the contoured transverse cross-section of the batten 3 along its side wall. The track 13 extends substantially for the entire length of the batten 3 (giving the invention the benefits that will be explained in the following paragraphs).

Following the at least partial accommodation of the peg 9 in the eyelet 11, the desired coupling between the panel 2 and the batten 3 occurs in that the protrusion 12 clamps the outer edges of the track 13 against the corresponding side face 2b of the panel 2.

It should be noted therefore that the choice to provide at least one track 13 that extends for the entire length of the batten 3 favors the activities of assembly (and any disassembly) of the kit 1. In the assembly step in fact, after achieving the intermediate configuration it is possible to slide the protrusion 12 into one end of the track 13, obviously taking care to keep mutually parallel the side wall of the batten 3 and the side face 2b of the panel 2 which must be in contact with each other after coupling.

Subsequently, it is possible to slide the batten 3 parallel to the side face 2b, in order to obtain in a practical manner the mutual arrangement that it is desired to obtain when coupling is complete: such activity is indeed favored by the guided sliding of the protrusion 12 in the track 13.

Likewise, in the step of disassembly, the batten 3 can be easily slid out, again using the track 13 as a guide for the sliding.

Even more specifically the protrusion 12 has, at the end portion thereof with the greater transverse cross-section, intended for insertion into the track 13, a flattened shape or a frustum shape.

The frustum shape structure can be efficaciously used in association with battens 3 made of metallic materials for example.

The flattened shape structure (obtained by shaping the end portion like a disk for example) is found to be of great interest when it is desired to clamp battens 3 made of polymeric material, for which in fact the frustum shape structure may be unsuitable (it may in fact damage and/or deform the edges of the track 13).

In a first embodiment, which reduces the number of components necessary for the correct operation of the kit 1 according to the invention, the protrusion 12 is shaped by a second end portion of the pin 6, which is opposite with respect to the first end portion 6a.

Instead, in the preferred embodiment (see also in particular the accompanying FIGS. 2 and 3), conveniently the protrusion 12 is constituted by a head 14 of a threaded rod 15: the head 14 therefore constitutes, in such embodiment, the end portion (flattened or frustum-shaped, or otherwise shaped), cited in the foregoing pages.

The rod 15 is in turn insertable into a threaded hole 16, axially provided in the pin 6 at the opposite end with respect to the first end portion 6a.

Such peculiar embodiment evidently makes it possible to adjust at will the distance of the head 14 from the first end portion 6a, by way of simply partially screwing (or unscrewing) the rod 15 in the hole 16. This makes it possible to freely vary, according to the specific applicative requirements (and/or the materials involved), the clamping force exerted by the protrusion 12 on the batten 3. In fact, the shorter the distance of the head 14 from the first end portion 6a, the greater the clamping force developed by the protrusion 12 on the batten 3: this evidently ensures the installation technician and/or the end consumer the ability to adjust the clamping according to the specific requirements and/or of the materials involved.

Positively, the panel 2 preferably comprises a plurality of seats 5, 7, which are provided at one or more greater faces 2a and/or side faces 2b. This evidently significantly increases the versatility of the invention, making it possible to obtain couplings between the same panel 2 and two or more battens 3, each one of which is coupled to a different side face 2b, obviously as a function of the specific configuration that it is desired to obtain for the final piece of furniture.

Likewise, preferably the same batten 3 comprises at least two rails 13, formed along respective side walls. Even more preferably, along each one of the four side walls a respective track 13 is defined.

Similarly to the observations for the panel 2 and with similar benefits, the choice shown in the previous paragraph makes it possible to mate two or more panels 2 to the same batten 3, according to the specific requirements.

In an embodiment of significant practical interest, shown in the accompanying figures by way of non-limiting example of application of the invention, the batten 3 is constituted by a profiled element that comprises first of all an elongated central body 17, which is hollow and substantially square in transverse cross-section.

Four ribs 18 extend radially from the four longitudinal corner edges of the central body 17 and support respective pairs of end flaps 19. As can be seen in FIGS. 2 and 3, the flaps 19 (which are associated with the same rib 18) are folded and on mutually opposite sides; by virtue of the configuration that derives from this, the track 13 is delimited by contiguous pairs of ribs 18, with the edges of the track 13 being defined by the flaps 19.

Advantageously, in order to ensure the installation technician and/or the end customer the ability to provide furniture of different type, preferably the kit 1 according to the invention comprises a plurality of panels 2 and/or of battens 3.

Likewise, for the same reasons, in the kit 1 that will be sold on the market the coupling means preferably will comprise a plurality of collars 4 and/or of pins 6 and/or of pegs 9.

Use of the kit according to the invention has already been partially explained.

Also with reference to the accompanying figures (and to FIG. 3 in particular), it has in fact already been seen that it is possible to insert the pin 6 into the second seat 7, until its first end portion 6a is introduced into the hole 8 provided along the collar 4, which in turn is previously inserted into the first seat 5.

To complete the coupling, the installation technician (be it a specialist technician or simply the end consumer), can align the batten 3 with the previously chosen side face 2b of the panel 2 by sliding the protrusion 12 into the track 13. After reaching the desired arrangement (usually, the one in which the side wall of the batten 3 is facing and proximate to the entire length of the corresponding side face 2b of the panel 2), the pin 6 can be anchored to the panel 2 by way of the at least partial accommodation of the peg 9 in the eyelet 11 of the pin 6 (as a result of the progressive screwing of the peg 9 into the female thread 10). This determines the clamping of the batten 3 by the protrusion 12, thus obtaining the desired coupling between the batten 3 and the panel 2.

It should be noted that preferably each batten 3 will be coupled to the respective panel 2 (or to the respective panels 2) by way of two or more pins 6 and respective protrusions 12 which protrude from the corresponding side face 2b of the panel 2.

During the installation, and in particular before the insertion of the pegs 9, the use of two or more protrusions 12 makes it possible to keep the batten 3 partially coupled to the panel 2, preventing the first from falling off, since the edges of the track 13 retain the protrusions 12, which are inserted with play into the track 13.

It should be noted therefore that the coupling is obtained as a consequence of the cooperation between the peg 9 (which is screwed into the female thread 10 of the collar 4) and the pin 6, which is in turn associated with the protrusion 12. Therefore, the optimal fixing of the batten 3 to the panel 2 is independent of the material with which the panel 2 (or the batten 3) is constituted: in fact, the components mentioned above cooperate only with each other and they do not discharge stresses on the panel 2. The peg 9, which is in particular responsible for the coupling, moves entirely within the collar 4 (fixed) and therefore, since it does not interact in any way with the panel 2, it does not pose any construction-related restriction on the latter.

Likewise, it has already been seen that the batten 3 can be made of any material, possibly taking care to carefully choose the shape structure of the protrusion 12 and of its end portion insertable into the track 13.

Evidently therefore, even internally hollow panels 2 can effectively be coupled to respective battens 3 by way of the kit 1: the method of coupling in fact does not pose any kind of limitation in that sense.

The kit 1 therefore makes it possible to stably couple together a panel 2 and a batten 3 which are intended to define furniture, of various types.

In fact, with reference also to the accompanying FIG. 1, it should be noted therefore that, by virtue of the battens 3 and of the coupling means, four panels 2 can be coupled in pairs, defining a kind of square frame that, optionally closed at the rear and/or at the front by further panels 2, constitutes a form of base module, which, optionally repeated, enables the composition of furniture such as kitchens, desks, cabinets etc.

It should be noted moreover that two or more modules thus defined can be mutually adjacent and joined at a conventional side panel 2 (as has previously been seen, each batten 3 can be coupled to multiple panels 2): therefore, with the kit 1 it is possible to reduce the number of components used overall (and of accessories of the type of lower supporting feet and the like).

The kit 1 according to the invention allows the use of any kind of material for panels 2 and battens 3 (and also for the coupling means).

This hugely increases the versatility, the modularity and the number of applications of potential interest.

It is noted in fact that the kit 1 evidently makes it possible to provide furniture (made up of variously-associated panels 2 and battens 3) in prized materials (metallic, composite, polymeric), in a practical and easy manner.

The possible configurations are evidently infinite, and in addition to the modules just defined, it is for example possible to provide connecting corners in a practical manner.

Moreover, the coupling means of the kit 1 according to the invention ensure a firm and stable coupling in any condition, and this confirms the capacity to withstand stresses and loads even if very heavy (which indeed occasionally happens with materials other than wood).

Furthermore, the kit 1 according to the invention ensures an easy decoupling of each batten 3 from the respective panel 2 (simply by unscrewing the peg 9 and extracting it from the female thread 10, and then sliding out the batten 3 by sliding the protrusion 12 guided in the track 13).

No component of the kit 1 is damaged during the coupling step and/or in the subsequent disassembly, and therefore it is possible to reuse the various components in a practical and easy manner.

Therefore, a further peculiarity of the invention is the fact that it allows an easy disassembly of each element (a single panel 2 for example) of the previously-built piece of furniture, if it is desired to replace it following damage, without requiring substitution of the entire piece of furniture or in any case of the entire base module.

Furthermore, advantageously the partial disassembly allows new reconfigurations or customizations of the piece of furniture: the user can for example decide to remove the previous front panel 2 made of wood, and to replace it with a more aesthetically attractive one made of aluminum or composite material, giving the kitchen a new look, more in line with the user's tastes or needs, in a simple and rapid manner.

Thus, the furniture obtained with the kit 1 according to the invention can be composed of panels 2 made of materials that are different from each other.

Also, it should be noted that the peculiarities of the kit 1 according to the invention allow not only an aesthetic conversion of the piece of furniture previously shown, but also a modification of its functionalities.

In fact, by being able to support even heavy loads (and with the simplicity of assembly/disassembly, already explained) it is possible for example to mount internal covering layers, already adapted to support drawers, shelves, utensils and various accessories.

Likewise, it is possible to remove the upper panel 2 to replace it with a cooktop, or to remove the front panel 2 to accommodate an appliance in the base module (a refrigerator, an oven or a dishwasher for example), in a practical and easy manner.

It should be noted that such results are indeed made possible, not only by the practical methods of coupling and decoupling conferred by the kit 1, but also by the ability to use the latter for panels 2 (and battens 3) made of any material.

It should likewise be noted that, by allowing the use of materials other than wood, the kit 1 is absolutely indicated for assembling furniture intended for furnishing outdoor spaces, and to be left exposed to bad weather.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

The disclosures in Italian Utility Model Application No. 202015000066688 (UB2015U086611) from which this application claims priority are incorporated herein by reference.

1-11. (canceled)

12. A kit for assembling furniture, which comprises:
at least one panel, which defines externally two mutually opposite greater faces, which are mutually joined by four side faces,
at least one joining batten,
means of coupling between said at least one panel and said at least one joining batten,
wherein said coupling means comprise:
at least one collar, insertable in at least one first seat defined at one of said greater faces,
at least one pin, partially insertable in at least one second seat defined at one of said side faces, said second seat leading to said first seat, for the introduction of a first end portion of said at least one pin into a transverse hole of said collar, which is previously inserted into said at least one first seat, with consequent definition of at least one intermediate configuration of assembly,
at least one threaded peg, insertable into a female thread defined in said collar, when said pin is arranged in said intermediate configuration, until the at least partial accommodation of said peg in an eyelet provided along said first end portion of said pin, for the coupling between said at least one panel and said at least one batten, clamped by a protrusion that can be coupled to a side wall of said batten and is associated stably with said pin at the opposite end with respect to said first end portion.

13. The kit according to claim 12, wherein one end of said peg has an externally-facing progressively tapered shape, for automatic alignment with said eyelet, internally countersunk, as a result of the progressive screwing of said peg into said female thread, with consequent optimal positioning of said pin in said second seat and improved clamping of said batten by said protrusion.

14. The kit according to claim 12, wherein said protrusion is slideably insertable into a longitudinal track, defined by a contoured transverse cross-section of said batten along said at least one side wall and extending substantially for the entire length of said batten, following the at least partial accommodation of said peg in said eyelet, said protrusion clamping the outside edges of said track against said side face of said panel, for the coupling thereof to said at least one batten.

15. The kit according to claim 12, wherein said protrusion has, at an end portion thereof with the greater transverse cross-section, intended for insertion into said track, a flattened shape or a frustum shape.

16. The kit according to claim 12, wherein said protrusion is shaped by a second end portion of said pin, opposite from said first end portion.

17. The kit according to claim 12, wherein said protrusion is constituted by a head of a threaded rod, insertable into a threaded hole, axially provided in said pin at the opposite end with respect to said first end portion, a distance of said head from said first end portion being adjustable at will, by way of partially screwing said rod into said hole, with consequent variation of a clamping force exerted by said protrusion on said batten.

18. The kit according to claim 12, wherein said at least one panel comprises a plurality of said seats which are provided at one or more of said greater faces and/or of said side faces.

19. The kit according to claim 14, wherein said at least one batten comprises at least two of said tracks, defined along respective said side walls.

20. The kit according to claim 19, wherein said batten is constituted by a profiled element that comprises an elongated central body, which is hollow and has a substantially square transverse cross-section, four ribs extending radially from the four longitudinal corner edges of said elongated central body and supporting respective pairs of end flaps, which are folded and on mutually opposite sides, said track being delimited by contiguous pairs of said ribs, with said edges defined by said flaps.

21. The kit according to claim 12, further comprising a plurality of said panels and/or of said battens.

22. The kit according to claim 12, wherein said coupling means between said at least one panel and said at least one joining batten comprise a plurality of said collars and/or of said pins and/or of said pegs.
